(19) United States
(12) Patent Application Publication
(10) Pub. No.: US 2026/0260654 A1
(43) Pub. Date: Sep. 3, 2026

(54) METHOD AND APPARATUS FOR PERFORMING VOICE COMMAND BASED ON GESTURE RECOGNITION

(71) Applicants: Hyundai Motor Company, Seoul (KR); Kia Corporation, Seoul (KR)

(72) Inventor: Sung Soo Park, Seoul (KR)

(73) Assignees: Hyundai Motor Company, Seoul (KR); Kia Corporation, Seoul (KR)

(21) Appl. No.: 19/294,749

(22) Filed: Aug. 8, 2025

(30) Foreign Application Priority Data
Mar. 25, 2025 (KR) 10-2025-0037954

(51) Int. Cl. G10L 15/24; G06F 3/01; G10L 15/18; G10L 15/22

(52) U.S. Cl. CPC G10L 15/24; G06F 3/017; G10L 15/1815; G10L 15/22; G10L 2015/223

(57) ABSTRACT

A method and an apparatus for executing a speech instruction based on gesture recognition are disclosed. According to an aspect of the present disclosure, there is provided a computer-implemented method performed by one or more computers, for executing a speech instruction, the method includes: classifying an utterance intent from an utterance of a user, and generating a slot, wherein the slot includes a plurality of attributes, and a value of an object to be controlled by the user through a speech instruction and at least one attribute related to a position of the object is set to a predetermined value; matching the utterance of the user with the pointing gesture of the user based on the utterance position information and the pointing gesture information of the user, wherein the pointing gesture is a gesture indicating a position or a direction of an object to be controlled by the user through a speech instruction; modifying a value of at least one attribute set to the predetermined value based on the pointing gesture of the user; and determining a control instruction for performing the speech instruction of the user based on the utterance intent and the modified slot; and causing a controller to operate a vehicle control based on the control instruction

### CROSS-REFERENCE TO RELATED APPLICATION

The present application claims priority to Korean Patent Application No. 10-2025-0037954, filed on Mar. 3, 2025 in the Korea Intellectual Property Office, the entire contents of which are incorporated herein by reference.

### TECHNICAL FIELD

The present disclosure relates to a method and an apparatus for executing a speech instruction based on gesture recognition.

### BACKGROUND

The statements in this section merely provide background information related to the present disclosure and do not necessarily constitute prior art.

With the development of techniques of artificial intelligence in recent years, applications thereof are also widening. In particular, a conversation system, for example, a chatbot or a virtual assistant, which enables a conversation with a user using a natural language, has been utilized in various fields, and the technology thereof has been gradually developed. In order for the dialog system to conduct a dialog with a user, it is necessary to understand an utterance from the user, that is, an input message, from the perspective of the dialog system. To achieve this Natural Language Understanding (NLU), the conversation system needs to derive the current context and the user's intent expected in that context from the conversation between the conversation system and the user, and analyze the input message based on the derived current context and/or intent.

In recent years, the scope of application of speech recognition services has been expanded to various fields such as automobiles. A speech recognition service is a service that allows a user to give an instruction to a device or software through speech. The speech recognition service is provided in various devices such as automobiles, smartphones, and home appliances, and helps the user to control the device without using a hand.

In the case of a vehicle to which a speech recognition service is applied, a speech instruction generated by an utterance of a user is transmitted to the vehicle to perform vehicle control. In this way, the user may lock/release the door of the vehicle or drive the air conditioner in advance to adjust the temperature inside the vehicle. For example, when the user utters “Open the passenger window,” the speech recognition system responds “I will open the passenger window” and opens the passenger window of the vehicle. When the user utters “What is auto hold,” the speech recognition system responds, “Auto hold is a function that keeps the vehicle stationary even when the foot is removed from the brake pedal.”

The above examples are cases where the driver ignites by clearly specifying a control target and a control method. However, there are many cases in which the driver utters abruptly during driving and the uttering includes an unclear term. In this case, it is difficult to grasp the utterance intent of the driver only by the natural language comprehension technique, and a problem arises in that the function intended by the driver may not be performed. For example, when the user utters “Open (pointing to the passenger window)” or “What is this (touching the auto hold button)?”, the control target and the control method are not clear, and the speech recognition system may not perform response and control in accordance with the user's intention.

To solve this problem, there is a method of interworking a speech recognition technology and a gesture recognition technology. This method is a method in which the speech recognition system recognizes the speech of the user (utterer), the gesture recognition system recognizes a gesture of the user (utterer), and combines the speech recognition result and the gesture recognition result to grasp the user's utterance intent.

However, when there are a plurality of occupants in the vehicle, several gestures may be recognized at the same time. Therefore, there is a need for a method capable of identifying a gesture of an utterer among various gestures in order to correctly classify a utterance intent of a user.

### SUMMARY

An object of the present disclosure is to provide a method and an apparatus capable of improving performance of a speech recognition system by using gesture recognition information in the speech recognition system.

An object of the present disclosure is to provide a method and an apparatus capable of identifying a gesture of a user (utterer) among a plurality of gestures when the plurality of the gestures are recognized when the user speaks.

The technical objects of the present disclosure are not limited to those described above, and other technical objects not mentioned above may be understood clearly by those skilled in the art from the descriptions given below.

An embodiment of the present disclosure provides a computer-implemented method performed by one or more computers, for executing a speech instruction, the method includes: classifying an utterance intent from an utterance of a user, and generating a slot, wherein the slot includes a plurality of attributes, and a value of an object to be controlled by the user through a speech instruction and at least one attribute related to a position of the object is set to a predetermined value, matching the utterance of the user with the pointing gesture of the user based on the utterance position information and the pointing gesture information of the user, wherein the pointing gesture is a gesture indicating a position or a direction of an object to be controlled by the user through a speech instruction, modifying a value of at least one attribute set to the predetermined value based on the pointing gesture of the user, determining a control instruction for performing the speech instruction of the user based on the utterance intent and the modified slot, and causing a controller to operate a vehicle control based on the control instruction.

Another embodiment of the present disclosure provides an apparatus for executing a speech instruction, the apparatus includes: at least one memory storing instructions, and at least one processor, wherein the at least one processor is configured to execute the instructions to classify an utterance intent from an utterance of a user, and generate a slot, wherein the slot includes a plurality of attributes, and a value of an object to be controlled by the user through a speech instruction and at least one attribute related to a position of the object is set to a predetermined value, match the utterance of the user with the pointing gesture of the user based on the utterance position information and the pointing gesture information of the user, wherein the pointing gesture is a gesture indicating a position or a direction of an object to be controlled by the user through a speech instruction, modify a value of at least one attribute set to the predetermined value based on the pointing gesture of the user, determine a control instruction for performing the speech instruction of the user based on the utterance intent and the modified slot, and causing a controller to operate a vehicle control based on the control instruction.

According to various embodiments of the present disclosure, there is an effect that the performance of a speech recognition system may be improved by using gesture recognition information in the speech recognition system.

According to various embodiments of the present disclosure, there is an effect of improving the performance of a speech recognition system by identifying a gesture of a user (utterer) among a plurality of gestures.

The technical effects of the present disclosure are not limited to the technical effects described above, and other technical effects not mentioned herein may be understood to those skilled in the art to which the present disclosure belongs from the description below.

### BRIEF DESCRIPTION OF THE DRAWINGS

FIG. 1 is a block diagram of an overall system according to an embodiment of the present disclosure.

FIG. 2 is a block diagram of a speech recognition system according to an embodiment of the present invention.

FIG. 3 is a diagram for showing examples of an utterance in which a control object and/or its position is unclear.

FIG. 4 is a flowchart for describing determining a control instruction consistent with an utterance intent of a user by using gesture recognition information, according to an embodiment of the present disclosure.

FIG. 5 is a flowchart for describing the process S430 of FIG. 4 in more detail.

FIGS. 6-10 are diagrams illustrating examples in which an attribute value of a slot related to an utterance intent of a user is determined using gesture recognition information, according to an embodiment of the present disclosure.

FIG. 11 is a schematic diagram of an illustrative configuration of a computing device that may be used to implement the apparatuses and methods described herein.

### DETAILED DESCRIPTION

Hereinafter, various exemplary of the present disclosure will be described in detail with reference to the accompanying drawings. In the following description, like reference numerals preferably designate like elements, although the elements are shown in different drawings. Further, in the following description of various embodiments, a detailed description of known functions and configurations incorporated therein will be omitted for the purpose of clarity and for brevity.

Additionally and alternatively, various terms such as first, second, A, B, (a), (b), etc., are used solely to differentiate one component from the other but not to imply or suggest the substances, order, or sequence of the components. Throughout this specification, when a part ‘includes’ or ‘comprises’ a component, the part is meant to further include other components, not to exclude thereof unless specifically stated to the contrary. The terms such as ‘unit’, ‘module’, and the like refer to one or more units for processing at least one function or operation, which may be implemented by hardware, software, or a combination thereof.

The following detailed description, together with the accompanying drawings, is intended to describe various exemplary of the present invention, and is not intended to represent the only embodiments in which the present invention may be practiced.

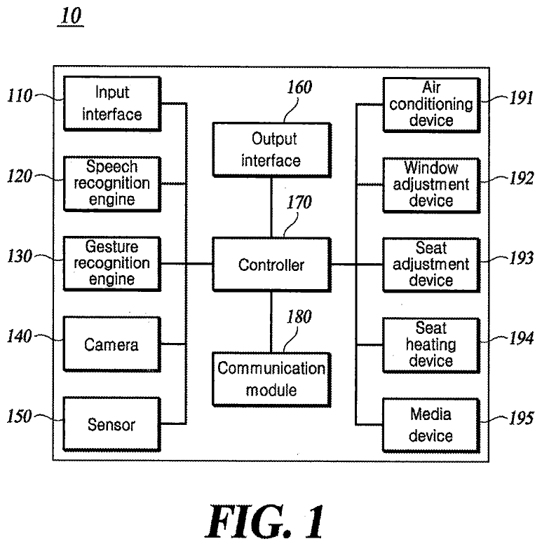

FIG. 1 is a block diagram of an overall system according to an embodiment of the present disclosure.

Referring to FIG. 1, a vehicle 10 includes an input interface 110, a speech recognition engine 120, a gesture recognition engine 130, a camera 140, a sensor 150, an output interface 160, a controller 170, a communication module 180, and vehicle control configurations 191, 192, 193, 194, 195.

The input interface 110 includes one or more microphones for receiving a user's speech input (i.e., user's utterance). The user entering a speech into the microphone may be a driver or a passenger.

The microphone may be provided at a position where the speech of the user in the vehicle 10 may be input. The microphone may be provided at a position such as a steering wheel, a center fascia, a headlining, a room mirror, or the like to receive a user's speech. It is also possible for two or more microphones to be provided in order to receive an utterance of a back seat passenger. The microphone for receiving an utterance of a back seat passenger may be provided in an armrest of a front seat and/or an armrest of the back seat, and may also be provided in a back seat door, a B-pillar, a C-pillar, or the like.

The speech recognition engine 120 is configured to analyze a user's speech input and transit a control instruction to the controller 170.

The speech recognition engine 120 stores an instruction table in advance to provide a control instruction corresponding to a user's speech input.

The instruction table includes predefined speech instructions and control instructions corresponding to the speech instructions. The speech instruction indicates vehicle control performed by the controller 170, and the control instruction is a trigger signal for causing the controller 170 to perform vehicle control.

First, the speech recognition engine 120 determines a speech instruction corresponding to the speech input of the user. Specifically, the speech recognition engine 120 converts the utterance of the user into text, and determines the utterance intent of the user from the converted text. The speech recognition engine 120 may use the utterance intent as a speech instruction. That is, the utterance intent may be treated the same as the speech instruction. For example, when the user utters “call <Hong Gil-dong>,” the speech recognition engine 120 may determine that the utterance intent is to “call by <name>,” and may determine that the speech instruction corresponding to the utterance may also be “call by <name>,”

Then, the speech recognition engine 120 refers to the instruction table to identify a control instruction corresponding to the speech instruction. The identified control instruction is sent to the controller 170. The controller 170 performs vehicle control according to the control instruction.

Further, the speech recognition engine 120 may extract keywords associated with the utterance intent from the speech input of the user. In the above example, the speech recognition engine 120 may extract “<Hong Gil-dong>” as a keyword. The extracted keyword may be sent to the controller 170 along with the control instruction.

In various embodiments, the speech recognition engine 120 may use the user's gesture information received from the gesture recognition engine 130 when the utterance intent and/or keyword for the user's speech input is unclear. The speech recognition engine 120 may classify speech intent or extract keywords by synthesizing the gesture recognition result and the speech recognition result.

In various embodiments, the speech recognition engine 120 may use the server 20 to analyze the user's speech input. The speech recognition engine 120 transmits the speech data and/or the image data to the server 20, receives an analysis result of the speech data and the image data from the server 20, and generates a control instruction based on the analysis result. Here, the analysis result may include an utterance intent and a slot.

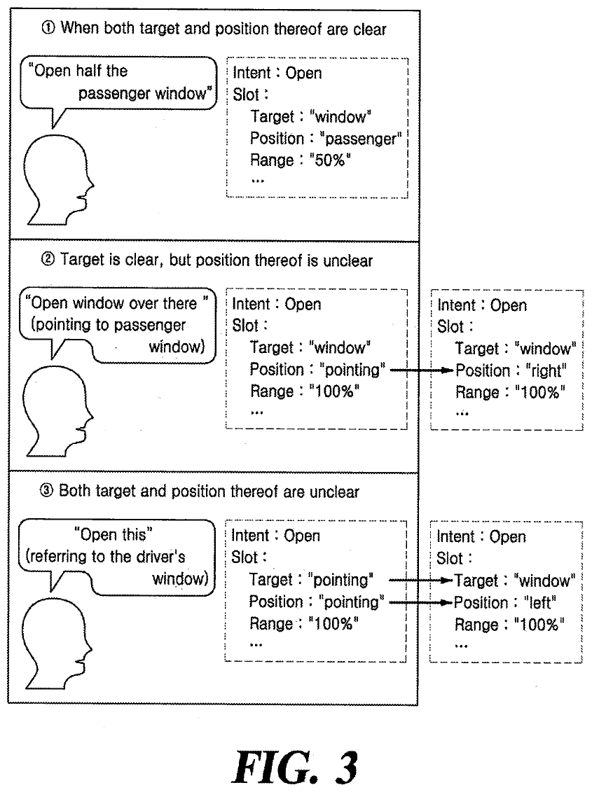

The speech recognition engine 120 is described in more detail in FIG. 3.

The gesture recognition engine 130 may identify one or more hand objects based on information received through at least one of the camera 140 and the sensor 150, and recognize gestures (e.g., hand gestures, finger gestures, air gestures, spatial gestures, non-contact gestures, etc.) of the hand objects.

The gesture recognition engine 130 may recognize the position, size, and shape of the gesture. When a plurality of hand objects are recognized, the gesture recognition engine 130 may recognize the position, size, shape, and motion information (e.g., motion distance, motion speed, motion direction, and the like) of each of the plurality of gestures.

The gesture recognition engine 130 may distinguish a gesture type (or an input) based on one and more of the position, size, shape, or motion information of the gesture. In particular, the gesture recognition engine 130 may determine whether the hand object is recognized as a pointing gesture. Here, the pointing gesture refers to a gesture (e.g., a motion of pointing at something with an index finger) in which a user points to a position or a direction of an object (target) to be controlled through a speech instruction. The pointing gesture may be of a pre-specified or set type.

When there are hand objects that overlap each other among the plurality of hand objects, the gesture recognition engine 130 may distinguish and separate the hand objects that overlap with each other based on at least one of the position, size, shape, and motion information of the gesture.

The gesture recognition engine 130 may distinguish whether the hand object is a right hand or a left hand based on one and more of the position, size, shape, or motion information of the gesture.

The gesture recognition engine 130 may check whether the hand object enters the field of view range of the camera 140 or the recognition range of the sensor 150, and determine whether a pointing gesture is input.

According to various embodiments, the vehicle 10 may transmit recognition information of the gesture input to a server (not shown). The server may improve the gesture recognition performance of the gesture recognition engine 130 by learning the recognition information of the gesture input provided from the vehicle 10 and providing the learned information to the vehicle 10.

The camera 140 may capture one and more of an internal image or an external image of the vehicle 10. The camera 140 may be provided to face the inside of the vehicle 10, may be provided to be facing the outside of the vehicle 10 and may be provided both inside and outside.

The camera 140 may take an image and pass it to the gesture recognition engine 130 and/or the controller 170.

The sensor 150 senses various information of the vehicle. In particular, the sensor 150 may sense movement (e.g., a hand gesture, a finger gesture, a non-contact gesture, an air gesture, a spatial gesture) of the non-contact object in at least some areas within the vehicle 10. The sensor 150 may include, for example, at least one of an image sensor (e.g., a camera), an optical sensor (e. g., an infrared sensor), an ultrasonic sensor, or a depth sensor.

Further, the sensor 150 may include a pressure sensor for sensing seat occupancy, a touch sensor, a sensor for collecting a biometric signal of a user, and the like.

The output interface 160 is configured to output information provided by an infotainment device (not shown).

The output interface 160 may include an AVN display, a cluster display, or a head up display (HUD) provided in a center fascia of the vehicle 10. Alternatively, the output interface 160 may include a back seat display provided on the back side of the head of the front seat so that the passenger of the back seat may see, and may include a display mounted on the headlining when the vehicle 10 is a multi-passenger vehicle. The display needs to be provided at a position viewable by an occupant of the vehicle 10, and there is no other limitation on the number or position of the displays.

The output interface 160 may include at least one utterer for outputting information provided by an infotainment device (not shown) in the form of sound.

The output interface 160 may include various devices, such as a haptic device that generates vibrations.

The controller 170 may control components in the vehicle 10. The controller 170 may perform various controls related to the vehicle 10.

The controller 170 performs various controls related to the vehicle 10 based on a control instruction signal received through the input interface 110, the speech recognition engine 120, or an infotainment device (not shown). For example, the controller 170 may control at least one of an air conditioning device 191, a window adjustment device 192, a seat adjustment device 193, a seat heating device 194, a media device 195, and a navigation device according to a control instruction.

In addition, the controller 170 may turn on/off the microphone, and process or store the speech input to the microphone or transfer it to another device through the communication module 180.

The controller 170 may control an image to be displayed on a display, and may control sound to be output to an utterer.

The communication module 180 may employ at least one of various wireless communication schemes such as Bluetooth, 4G communication, 5G communication, and Wi-Fi to transmit and receive signals to and from other devices. Alternatively, information may be exchanged with another device through a cable connected to a Universal Serial Bus (USB) port, an AUX (auxiliary) port, or the like.

The communication module 180 may include two or more communication interfaces that support different communication manners, and may transmit and receive information to and from two or more other devices.

For example, the communication module 180 may communicate with a mobile device located inside the vehicle 10 through Bluetooth communication to receive information (a user's image, a user's speech, a contact, a schedule, and the like) obtained by the mobile device or stored in the mobile device, and may communicate with a server through a 4G or 5G communication method to transmit a user's speech and receive a signal necessary for providing a service desired by the user. It is possible to transmit and receive necessary signals to and from a server via a mobile device connected to the vehicle 10.

The vehicle 10 may include a navigation device that performs road guidance, an air conditioning device 191 that adjusts an internal temperature, a window adjustment device 192 that adjusts opening/closing of a window, a seat adjustment device 193 that adjusts a position, a height, or an angle of a seat, a seat heating device 194 that heats a seat, a media device 195 that reproduces media or real-time streaming, and the like.

The foregoing devices may provide convenience functions related to the vehicle 10, and some of them may be omitted depending on the vehicle type and option. Other devices may be further included in addition to the foregoing devices. A configuration related to driving of the vehicle 10 is a well-known configuration, and description thereof will be omitted herein.

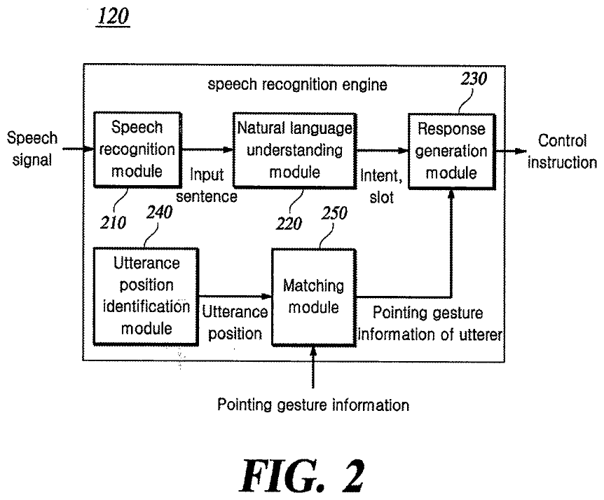

FIG. 2 is a block diagram of a speech recognition system according to an embodiment of the present invention.

A speech recognition engine 120 recognizes and understands a user's utterance, and provides a response (such as a control instruction signal for performing vehicle control) corresponding to the user's utterance. In the present disclosure, a user represents a driver or a passenger.

The speech recognition engine 120 includes a speech recognition module 210 that converts a user's utterance and a speech instruction into text, a natural language understanding module 220 that determines the user's utterance intent and generates a slot, a response generation module 230 that performs processing for providing a response corresponding to the user's utterance intent, a utterance position identification module 240 that identifies the user's position, and a matching module 250 that matches the user's utterance with a gesture. The speech recognition engine 120 may further include a dialogue manager that manages the overall dialogue between the speech recognition engine 120 and the user.

The speech recognition engine 120 includes at least one processor and a memory including at least one instruction. The speech recognition engine 120 may perform the functions of the speech recognition module 210, the natural language understanding module 220, the response generation module 230, the utterance position identification module 240, and the matching module 250 through execution of the instruction by the at least one processor.

Some or all of the speech recognition engine 120 may be implemented by the controller 170 of the vehicle 10 in FIG. 1.

The speech recognition module 210 acquires a user's utterance received from a microphone in the vehicle, and converts the user's utterance into an input sentence by using at least one Speech to Text (STT) engine. The STT engine may convert the speech signal into text by applying a speech recognition algorithm or a deep learning model to the speech signal indicating the user's utterance.

For example, the speech recognition module 210 may extract a feature vector from a user utterance by applying a feature vector extraction technique such as cepstrum, linear predictive coding (LPC), Mel Frequency Cepstral Coefficient (MFCC), or filter bank energy. The speech recognition module 210 may obtain a recognition result through comparison between the extracted feature vector and the trained reference pattern. To this end, an acoustic model that models and compares signal characteristics of speech or a language model that models a linguistic order relationship such as a word or a syllable corresponding to a recognition vocabulary may be used.

The speech recognition module 210 may convert a user utterance into an input sentence in the form of text based on a model to which machine learning or deep learning is applied.

The natural language understanding module 220 classifies the user's utterance intent included in the input sentence and extracts at least one slot indicating meaningful information related to the utterance intent. Here, the slot means a semantic object necessary for providing a control instruction according to an utterance intent.

The slot includes at least one attribute. The attributes of the slot may be predefined for each utterance intent. For example, when the utterance intent is ‘Open’, the slot may include a target attribute that is an attribute indicating a control target (e.g., a window, a door, a trunk, or the like) and a position attribute that is an attributes indicating a position of the target.

In various embodiment, the natural language understanding module 220 may compare the given grammar with the input sentence to determine the user's utterance intent and slot for the input sentence. For example, when the preset grammar is “Open <position><target>” and the input sentence is “Open the passenger window,” the natural language understanding module 220 may determine that the utterance intent is “Open,” the target attribute of the slot is “window,” and the position attribute of the slot may be “passenger.”

In various embodiment, the natural language understanding module 220 may determine the utterance intent and slot for the user's input sentence using tokenization, a deep learning model, or the like.

Specifically, the natural language understanding module 220 segments the input sentence into tokens in morphemes. Additionally and alternatively, the natural language understanding module 220 may tag each token with a part-of-speech.

The natural language understanding module 220 projects the tokens into the vector space. Each of the tokens or combination of tokens is converted into an embedding vector. For performance improvement, sequence embedding, position embedding, and the like may be performed together.

The natural language understanding module 220 determines the utterance intent and the slot for the input sentence by grouping the embedding vectors or applying the first deep learning model and the second deep learning model to the embedding vectors, respectively. Here, the first deep learning model may be a recurrent neural network that is pre-trained to classify an utterance intent in response to an input of embedding vectors. The second deep learning model may be a recurrent neural network that is pre-trained to determine a slot corresponding to the input of the embedding vectors.

In further various embodiments, the natural language understanding module 220 may extract information such as a domain, a named entity, or a speech act from the input sentence using the natural language understanding module 220. The domain is information for identifying the subject of the user utterance (e.g., vehicle control, information provision, text transmission, navigation function, etc.). The named entity represents a unique noun such as a person's name, a place name, an organization name, a time, a date, and money. An analysis of the speech act is a task of analyzing the utterance intent, such as whether the user asks a question, makes a request, responds, or simply expresses an emotion. Information such as a domain, a named entity, or a speech act may be used for at least one operation of classifying a user's utterance intent, extracting a slot, or generating a response to the user's utterance.

On the other hand, there is a case where an object to be controlled by a user and a position thereof are unambiguously designated and uttered. In this case, there is a limit to obtaining the target attribute and the position attribute of the slot by the natural language comprehension technique. The method according to the present disclosure supplements the target attribute and the position attribute of a slot by using a gesture recognition technique.

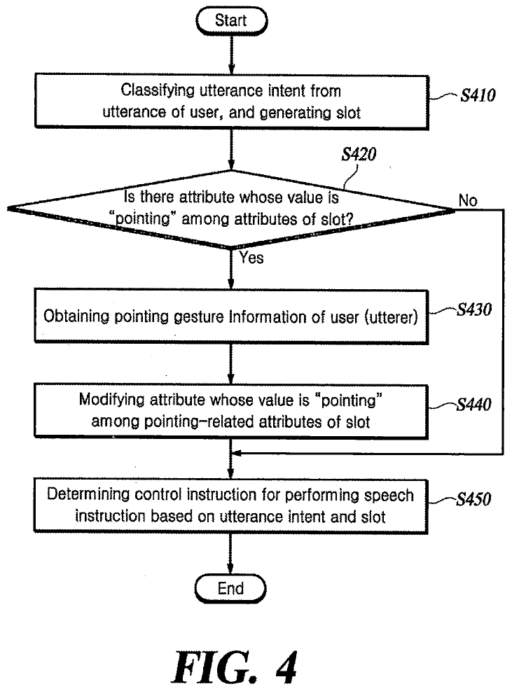

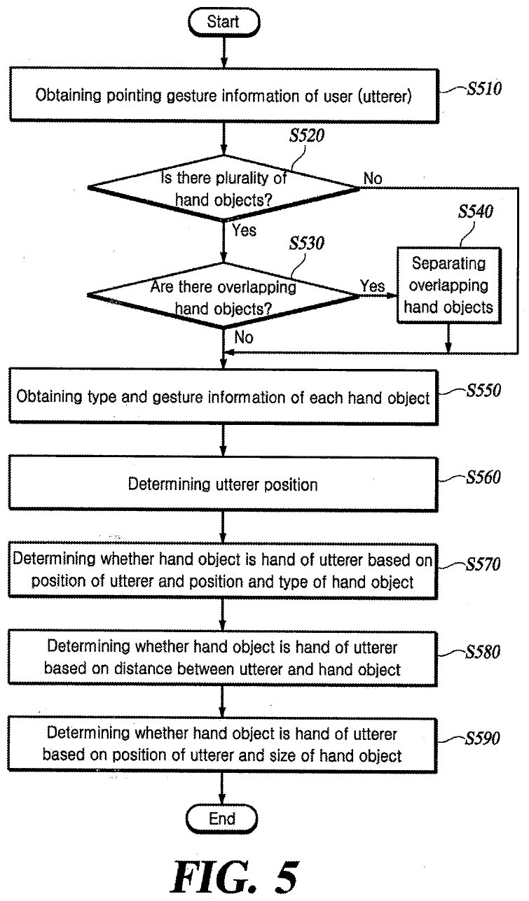

In various embodiments, the natural language understanding module 220 sets the attribute value to a predetermined value (in the present embodiments, “pointing”) for attributes that may be supplemented using gesture recognition technology among the attributes of the slot. Thereafter, the attribute whose value is “pointing” is modified (altered) to a specific value by the response generation module 230, so that the speech recognition engine 120 may output a control instruction signal that conforms to the user's intention. A specific method of modifying (changing) an attribute whose value is “pointing” by using gesture recognition information is described in detail with reference to FIGS. 4 to 5.

FIG. 3 is a diagram for showing examples of an utterance in which a control object and/or its position is unclear. In each of the examples of FIG. 3, the picture on the left shows the user's utterance, and the dotted boxes show the utterance intent and slot.

The first example of FIG. 3 shows a case where a user clearly utters an object to be controlled and the position thereof. When the user's utterance is “open half the passenger window”, then the control object and/or its position is clear. Therefore, the natural language understanding module 220 may determine that the utterance intent is “open,” the target attribute of the slot is “window,” and the position attribute of the slot may be “passenger.”

The second example of FIG. 3 shows a case where the object to be controlled by the user is uttered clearly, but the position thereof is uttered in an unclear manner. When the user's utterance is “Open the window over there (pointing to the passenger window),” the control target is clear as a “window,” but the “position of the window” is unclear. Therefore, the natural language understanding module 220 may determine that the utterance intent is “Open” and the target attribute of the slot is “window,” but determines that the position attribute of the slot may be “pointing.”

The response generation module 230 may modify the value of the position attribute from “pointing” to “right” using the pointing gesture information of the user (i.e., the user). The speech recognition engine 120 may output a control instruction signal for performing “opening the passenger window” based on the utterance intent and the modified slot.

The third example of FIG. 3 shows a case where the user utters both the object to be controlled and the position thereof in an unclear manner. When the user's utterance is “Open this (pointing to the driver's seat window),” there is no target word, and both the control target and its position are unclear. Therefore, the natural language understanding module 220 classifies the utterance intent as “open,” but determines that the target attribute and the position attribute of the slot are “pointing.”

The response generation module 230 may modify the value of the target attribute from “pointing” to “window” and the value of the position attribute from “pointed” to “right” by using the pointing gesture information of the user (that is, the utterer). The speech recognition engine 120 may output a control instruction signal for performing “Open the driver's seat window” based on the utterance intent and the modified slot.

The response generation module 230 performs processing for providing a response corresponding to the user's utterance intent. Here, the response includes a control instruction for performing vehicle control according to a speech instruction of the user. The air conditioning device 191, the window adjustment device 192, the seat adjustment device 193, the seat heating device 194, the media device 195, and the like are controlled according to a control instruction output from the response generation module 230.

The response generation module 230 determines the control instruction based on the utterance intent and the at least one slot received from the natural language understanding module 220.

As described above with reference to FIG. 3, when there is an attribute whose value is “pointing” among the attributes of the slot, the response generation module 230 may modify the “pointing” attribute value to a specific value by using the pointing gesture information of the utterer received from the matching module 250.

The response generation module 230 determines the control instruction based on the utterance intent and the modified at least one slot.

The utterance position identification module 240 receives a speech instruction of an occupant in the vehicle, and identifies a position of the occupant who has ignited the speech instruction. The utterance position identification module 240 may identify a position where the speech instruction is uttered.

The utterance position identification module 240 may identify the position of the occupant who uttered the speech instruction or the seat position of the occupant based on at least one of a spot-forming algorithm, microphones signal strengths, sensing sensors provided in each seat, and microphone activation buttons.

As various examples, the utterance position identification module 240 may identify a position of an occupant who has uttered a speech instruction based on signal strengths input to each of the microphones in the vehicle. The utterance position identification module 240 may determine that the speech instruction is uttered at a position close to the microphone(s) to which the strong intensity signal is input.

As various examples, the utterance position identification module 240 may identify the position of the passenger by identifying the seat position of the passenger using a sensing sensor provided at each seat position. Here, the sensing sensor may be a pressure sensor or a distance sensor. When a speech instruction is received in a state in which one seat is occupied, the utterance position identification module 240 may determine that the speech instruction is uttered in the occupied seat.

As various examples, the utterance position identification module 240 may identify the position of the passenger by identifying the seat position of the passenger who has uttered the speech instruction by using the micro silver activation button provided at each seat position. When a certain microphone activation button is changed to an on state immediately before the speech instruction is received, it is determined that the speech instruction is uttered at the seat position provided with the microphone activation button. Here, the microphone activation button may be a push-to-talk button.

The matching module 250 matches the user's utterance with the user's pointing gesture.

Specifically, the matching module 250 matches the user's utterance with the user's pointing gesture based on the position information of the user (utterer) received from the utterance position identification module 240 and the pointing gesture information received from the gesture recognition engine 130. Here, the pointing gesture information may include information about at least one hand object, and the information about each hand object may include position, size, shape, type (left hand or right hand), and motion information of each hand object.

In various embodiments, the matching module 250 may determine whether the hand object is a hand of the user (utterer) based on the position of the user (utterer) and the position and type of the hand object. For example, when a left hand object is located to the left of the utterer or a right hand object is located on the right of the utterer, the matching module 250 may determine that the hand object is the utterer's hand. Conversely, when the left hand object is located to the right of the utterer or the right hand object is located on the left of the utterer, the matching module 250 may determine that the hand object is not a hand of the utterer.

In various embodiments, the matching module 250 may determine whether the hand object is a hand of the user (utterer) based on a distance between the user (utterer) and the hand object. For example, when a plurality of left hand objects are located on the left side of the utterer, the matching module 250 may determine the left hand object located closest to the utterer among the plurality of left hand object as the user's hand. In addition, when a plurality of right hand objects are located on the right side of the utterer, the matching module 250 may determine the right hand object located closest to the utterer among the plurality of right-hand hand objects as the user's hand.

In various embodiments, the matching module 250 may determine whether the hand object is a hand of the user (utterer) based on the position of the user (utterer) and the size of the hand object. For example, when a plurality of left hand objects are located on the left side of the utterer, and the utterer is located in the front seat, the matching module 250 may determine that a left hand object with a size larger than a predetermined value among the plurality of left hand objects is a hand of the user. In addition, when a plurality of right hand hand objects are located on the right side of the utterer and the utterer is located in the back seat, the matching module 250 may determine that a right hand object smaller than a predetermined value among the plurality of right hand objects is a hand of the user.

When there are a plurality of occupants in the vehicle, several hand gestures may be recognized by the gesture recognition engine. The matching module 250 may identify a hand gesture of the utterer among the plurality of hand gestures, so that the gesture recognition result may be used to improve the performance of the speech recognition service.

The speech recognition engine 120 may include at least one processor and a memory including at least one instruction, and may perform the functions of the speech recognition module 210, the natural language understanding module 220, the response generation module 230, the utterance position identification module 240, and the matching module 250 through the instruction execution by the at least one processor. The speech recognition engine 120 may include a communication unit for communication with an external device.

FIG. 4 is a flowchart for describing determining a control instruction consistent with an utterance intent of a user by using gesture recognition information, according to an embodiment of the present disclosure.

The natural language understanding module 220 classifies the utterance intent from the user's utterance, and generates at least one slot (S410). Specifically, the natural language understanding module 220 may receive the input sentence generated from the utterance of the user by the speech recognition module 210, classify the utterance intent of the user included in the input sentence, and generate at least one slot indicating meaningful information related to the utterance intent.

The natural language understanding module 220 sets the value of the attributes related to the pointing gesture among the attributes of the slot to “pointing” when the user utters the object to be controlled and the position thereof in an unclear manner and fails to obtain the target attribute and the position attribute of the slot by the natural language com comprehension technique.

It is determined whether there is an attribute whose value is “pointing” among the pointing-related attributes of the slot (S420). When there is no attribute that the value is “pointing” (S420—NO), the response generation module 230 determines a control instruction for performing a speech instruction based on the utterance intent and the at least one slot obtained in step S410 (S450). When there is an attribute that the value is “pointing” (S420—YES), the matching module 250 obtains the pointing gesture information of the utterer (user) based on the position information of the user (utterer) received from the utterance position identification module 240 and the gesture recognition information received from the gesture recognition engine 130 (S430). Process S430 is described in detail with reference to FIG. 5.

The response generation module 230 modifies the “pointing” attribute value to a specific value by using the pointing gesture information of the utterer (user) received from the matching module 250 (S440).

The response generation module 230 determines a control instruction for performing a speech instruction based on the utterance intent and the modified at least one slot (S450).

FIG. 5 is a flowchart for describing the process S430 of FIG. 4 in more detail.

The gesture recognition engine 130 identifies one or more hand objects based on information received through at least one of the camera 140 and the sensor 150 (S510).

It is determined whether a plurality of hand objects have been identified (S520). When one hand object is identified (S520—NO), the process moves to step S550. When a plurality of hand objects are identified (S520—YES), it is determined that overlapping hand objects exist (S530). When there are overlapping hand objects (S530—YES), the corresponding hand objects are separated (S540). When there are no overlapping hand objects (S530—NO). The process moves to step S550.

The gesture recognition engine 130 obtains a type of each hand object and gesture information (S550). Here, the type of the hand object indicates whether the hand object is a left hand or a right hand. Further, the gesture information of the hand object includes a position, a size, a shape, and a type of the gesture. Here, one of the types of gestures is a pointing gesture. The pointing gesture is a gesture in which a user points to a position or a direction of an object (target) to be controlled through a speech instruction (e.g., a motion pointing to something with an index finger).

The utterance position identification module 240 receives a speech instruction of an occupant in the vehicle, and identifies a position of the occupant who has uttered the speech instruction (S560). That is, the utterance position identification module 240 identifies a position where the speech instruction is uttered.

The matching module 250 determines whether the hand object is a hand of the user (utterer) based on the position of the user (utterer) and the position and type of the hand object (S570).

The matching module 250 determines whether the hand object is a hand of the user (utterer) based on a distance between the user (utterer) and the hand object (S580).

The matching module 250 determines whether the hand object is a hand of the user (utterer) based on the position of the user (utterer) and the size of the hand object (S590).

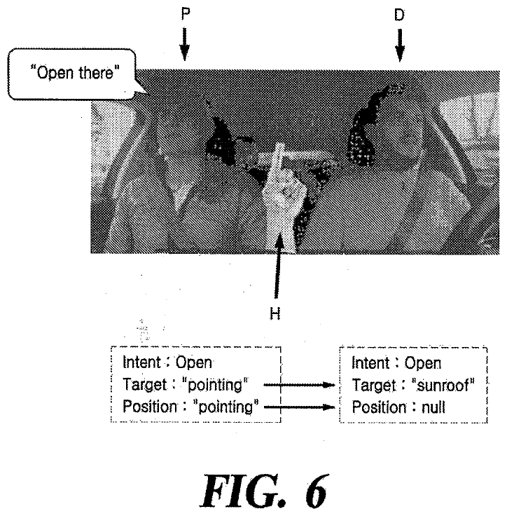

FIGS. 6-10 are diagrams illustrating examples in which an attribute value of a slot related to an utterance intent of a user is determined using gesture recognition information, according to an embodiment of the present disclosure.

FIG. 6 shows a situation in which the passenger P sitting in the passenger seat points to the sunroof with his left hand and utters “open there.”

Since the passenger P utters both the control target and the position thereof in an unclear manner, the utterance intent may be classified as “open,” but the target attribute value and the position attribute value of the slot may be set to “pointing.”

It is determined whether the hand object H is the hand of the passenger P by using the position information of the passenger P obtained by the utterance position identification module 240 and the pointing gesture information obtained by the gesture recognition engine 130. Specifically, since the hand object H that is the left hand is on the left side of the passenger P, it is determined that the hand object H is the hand of the passenger P.

Using the pointing gesture information of the hand object H, the target attribute value may be modified from “pointing” to “sunroof,” and the position attribute value may be modified to null from “pointing.” A control instruction signal for performing “opening the sunroof” based on the utterance intent and the modified slot is output.

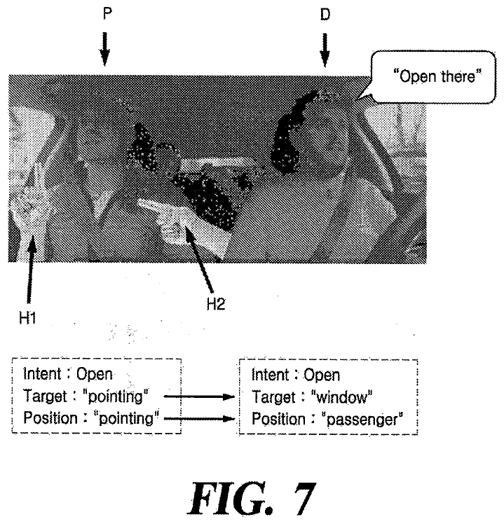

FIG. 7 shows a situation in which the driver D points to the passenger side window with his left hand and fires, “Open it there.”

Since the driver D has uttered both the control target and the position thereof in an unclear manner, the utterance intent is classified as “open,” but the target attribute value and the position attribute value of the slot are set to “pointing.”

It is determined whether the hand objects H1 and H2 are hands of the driver D by using the position information of the driver D obtained by the utterance position identification module 240 and the pointing gesture information obtained by the gesture recognition engine 130. Specifically, it is determined whether each of the right hand objects H1 and H2 is on the right side of the driver D. Since the hand objects H1 and H2 are all on the right side of the driver D, it is determined that the second hand object H2, which is the hand object closest to the driver D among the hand objects H1, H2, is the hand of the driver D.

Using the pointing gesture information of the second hand object H2, the target attribute value is modified from “pointing” to “window,” and the position attribute value is modified to “passenger” from “pointing.” A control instruction signal for performing “opening the passenger window” based on the utterance intent and the modified slot is output.

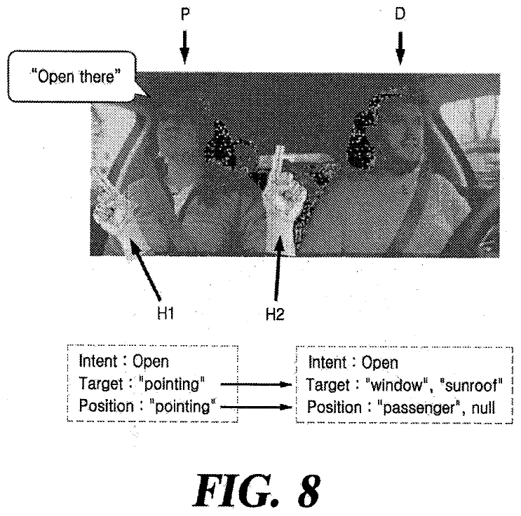

FIG. 8 shows a situation in which the passenger P sitting in the passenger seat points to the passenger window with the left hand and the sunroof with the right hand, and utters “open here.”

Since the passenger P utters both the control target and the position thereof in an unclear manner, the utterance intent is classified as “open,” but the target attribute value and the position attribute value of the slot are set to “pointing.”

It is determined whether the hand objects H1 and H2 are hands of the passenger P by using the position information of the passenger P obtained by the utterance position identification module 240 and the pointing gesture information obtained by the gesture recognition engine 130. Specifically, since the first hand object H1, which is the right hand, is on the right side of the passenger P, it is determined that the first hand object H1 is the hand of the passenger P. In addition, since the second hand object H2, which is the left hand, is on the left side of the passenger P, it is determined that the second hand object H2 is the hand of the passenger P.

Using the pointing gesture information of the hand objects H1 and H2, the target attribute value is modified from “pointing” to “window” and “sunroof,” and the position attribute value is modified to “passenger” and null from “pointing.” A control instruction signal for performing “opening the passenger window” and “opening the sunroof” based on the utterance intent and the modified slot is output.

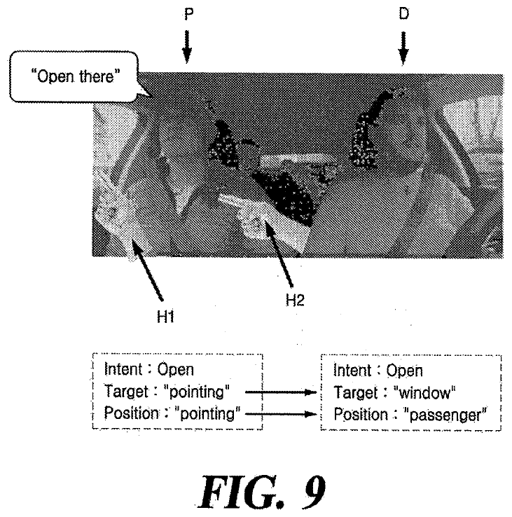

FIG. 9 shows a situation in which the passenger P sitting in the passenger seat points to the passenger window with his left hand and utters “open here.”

Since the passenger P utters both the control target and the position thereof in an unclear manner, the utterance intent is classified as “open,” but the target attribute value and the position attribute value of the slot are set to “pointing.”

It is determined whether the hand objects H1 and H2 are hands of the passenger P by using the position information of the passenger P obtained by the utterance position identification module 240 and the pointing gesture information obtained by the gesture recognition engine 130. Specifically, since the first hand object H1, which is the right hand, is on the right side of the passenger P, it is determined that the first hand object H1 is the hand of the passenger P. On the other hand, since the second hand object H2, which is the right hand, is on the left side of the passenger P, it is determined that the second hand object H2 is not the hand of the passenger P.

Using the pointing gesture information of the first hand object H1, the target attribute value is modified from “pointing” to “window,” and the position attribute value is modified form “pointing” into “passenger.” A control instruction signal for performing “opening the passenger window” based on the utterance intent and the modified slot is output.

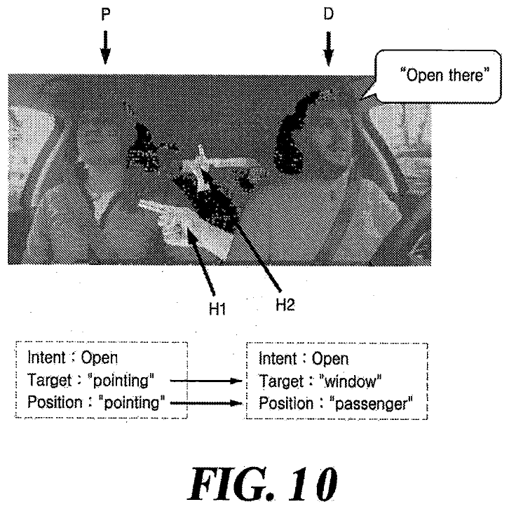

FIG. 10 shows a situation in which the driver D points to the passenger side window with his left hand and fires, “Open there.”

Since the driver D has ignited both the control target and the position thereof in an unclear manner, the utterance intent is classified as “open,” but the target attribute value and the position attribute value of the slot are set to “pointing.”

It is determined whether the hand objects H1 and H2 are hands of the driver D by using the position information of the driver D obtained by the utterance position identification module 240 and the pointing gesture information obtained by the gesture recognition engine 130. Specifically, it is determined whether each of the right hand objects H1 and H2 is on the right side of the driver D. In addition, a distance between the utterance position of the driver D and each of the hand objects H1 and H2 is compared. Since the hand objects H1 and H2 are all on the right side of the driver D, and the distance between the utterance position of the driver D and each of the hand objects H1, H2 is the same, the sizes of each of the hand object H1, H2 are compared. Since the driver D is seated in the front seat, it is determined that the first hand object H1, which is a large-sized hand object among the hand objects H1 and H2, is a hand of the driver D.

Using the pointing gesture information of the first hand object H1, the target attribute value is modified from “pointing” to “window,” and the position attribute value is modified form “pointing” into “passenger.” A control instruction signal for performing “opening the passenger window” based on the utterance intent and the modified slot is output.

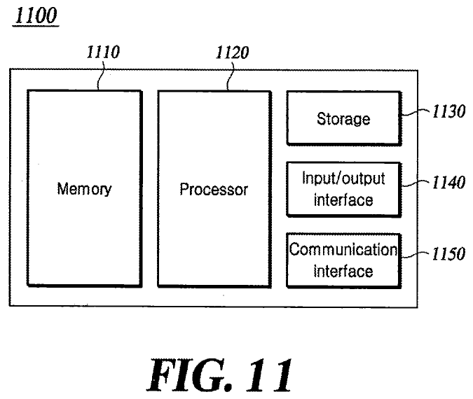

FIG. 11 is a schematic diagram of an illustrative configuration of a computing device that may be used to implement the apparatuses and methods described herein.

A computing device 1100 may include some or all of a memory 1110, a processor 1120, a storage 1130, an input and output (I/O) interface 1140, and a communication interface 1150. The computing device 1100 may structurally and/or functionally include at least a portion of a device according to the present disclosure. The computing device 1100 may be a stationary computing device such as a desktop computer, a server, or an AI accelerator, or a mobile computing device such as a laptop computer or a smart phone. The computing device 1100 may be implemented as any specialized hardware accelerator capable of processing operations on an artificial intelligence model in an efficient manner. The computing device 1100 may include a graphics processing unit (GPU), a tensor processing unit (TPU), or a neural processing unit (NPU).

The memory 1110 may store a program that allows the processor 1120 to perform methods or operations according to various embodiments of the present disclosure. For example, the program may include a plurality of instructions executable by the processor 1120, and the method or operations described above may be performed by executing the plurality of instructions by the processor 1120. The memory 1110 may be a single memory or a plurality of memories. In this case, information required to perform the methods or operations according to various embodiments of the present disclosure may be stored in a single memory or divided and stored in the plurality of memories. When the memory 1110 is configured of the plurality of memories, the plurality of memories may be physically separated. The memory 1110 may include at least one of a volatile memory and a non-volatile memory. The volatile memory includes a static random access memory (SRAM), a dynamic random access memory (DRAM), or the like, and the non-volatile memory includes a flash memory.

The processor 1120 may include at least one core capable of executing at least one instruction. The processor 1120 may execute instructions stored in the memory 1110. The processor 1120 may be a single processor or a plurality of processors.

The storage 1130 maintains the stored data even when power supplied to the computing device 1100 is cut off. For example, the storage 1130 may include a non-volatile memory and may include a storage medium such as a magnetic tape, optical disk, or magnetic disk. A program stored in the storage 1130 may be loaded into the memory 1110 before being executed by the processor 1120. The storage 1130 may store files created in a program language, a program created from a file by a compiler or the like may be loaded into the memory 1110. The storage 1130 may store data to be processed by the processor 1120 and/or data processed by the processor 1120.

The I/O interface 1140 may provide an interface with an input device such as a keyboard, a mouse, or the like and/or an output device such as a display device, a printer, or the like. An user can trigger execution of a program by the processor 1120 through the input device and/or check a processing result of the processor 1120 through the output device.

The communication interface 1150 may provide access to an external network. The computing device 1100 may communicate with other devices through a communication interface 1150.

Each element of the apparatus or method in accordance with the present invention may be implemented in hardware or software, or a combination of hardware and software. The functions of the respective elements may be implemented in software, and a microprocessor may be implemented to execute the software functions corresponding to the respective elements.

Various embodiments of systems and techniques described herein can be realized with digital electronic circuits, integrated circuits, field programmable gate arrays (FPGAs), application specific integrated circuits (ASICs), computer hardware, firmware, software, and/or combinations thereof. The various embodiments can include implementation with one or more computer programs that are executable on a programmable system. The programmable system includes at least one programmable processor, which may be a special purpose processor or a general purpose processor, coupled to receive and transmit data and instructions from and to a storage system, at least one input device, and at least one output device. Computer programs (also known as programs, software, software applications, or code) include instructions for a programmable processor and are stored in a “computer-readable recording medium.”

The computer-readable recording medium may include all types of storage devices on which computer-readable data can be stored. The computer-readable recording medium may be a non-volatile or non-transitory medium such as a read-only memory (ROM), a random access memory (RAM), a compact disc ROM (CD-ROM), magnetic tape, a floppy disk, or an optical data storage device. In addition, the computer-readable recording medium may further include a transitory medium such as a data transmission medium. Furthermore, the computer-readable recording medium may be distributed over computer systems connected through a network, and computer-readable program code can be stored and executed in a distributive manner.

Although operations are illustrated in the flowcharts/timing charts in this specification as being sequentially performed, this is merely an exemplary description of the technical idea of one embodiment of the present disclosure. In other words, those skilled in the art to which one embodiment of the present disclosure belongs may appreciate that various modifications and changes can be made without departing from essential features of an embodiment of the present disclosure, that is, the sequence illustrated in the flowcharts/timing charts can be changed and one or more operations of the operations can be performed in parallel. Thus, flowcharts/timing charts are not limited to the temporal order.

Although various exemplary of the present disclosure have been described for illustrative purposes, those skilled in the art will appreciate that various modifications, additions, and substitutions are possible, without departing from the idea and scope of the claimed invention. Therefore, various exemplary of the present disclosure have been described for the sake of brevity and clarity. The scope of the technical idea of the present embodiments is not limited by the illustrations. Accordingly, one of ordinary skill would understand that the scope of the claimed invention is not to be limited by the above explicitly described embodiments but by the claims and equivalents thereof.

What is claimed is:

1. A computer-implemented method performed by one or more computers, for executing a speech instruction, the method comprising:
classifying an utterance intent from an utterance of a user, and generating a slot, wherein the slot includes a plurality of attributes, and a value of an object to be controlled by the user through a speech instruction and at least one attribute related to a position of the object is set to a predetermined value;
matching the utterance of the user with a pointing gesture of the user based on utterance position information and pointing gesture information of the user, wherein the pointing gesture is a gesture indicating a position or a direction of an object to be controlled by the user through a speech instruction;
modifying a value of at least one attribute set to the predetermined value based on the pointing gesture of the user;
determining a control instruction for performing the speech instruction of the user based on the utterance intent and the modified slot; and
causing a controller to operate a vehicle control based on the control instruction.

2. The method of claim 1,
wherein the slot comprises a target attribute and a position attribute, and
the target attribute is an object that the user intends to control via a speech instruction, and the position attribute is a position of the object.

3. The method of claim 2,
wherein the pointing gesture information comprises information about at least one hand object, and the information about the at least one hand objects includes one or more of a position, a size, a shape, a type (a left hand or a right hand), or motion information of each hand object.

4. The method of claim 3, comprising:
before matching the utterance of the user with the pointing gesture of the user,
distinguishing and separating a plurality of hand objects that overlap each other; and
distinguishing whether the at least one hand object is a right hand or a left hand.

5. The method of claim 4,
wherein matching the utterance of the user with the pointing gesture of the user comprises:
determining whether the at least one hand object is a hand of the user based on a utterance position of the user and the position and type of the at least one hand object.

6. The method of claim 5,
wherein determining whether the at least one hand object is a hand of the user based on the utterance position of the user and the position and type of the at least one hand object comprises:
determining a left hand object located on a left side of the user and a right hand object located on a right side of the user as hands of the user.

7. The method of claim 4,
wherein matching the utterance of the user with the pointing gesture of the user comprises:
determining whether the at least one hand object is a hand of the user based on a distance between an utterance position of the user and the at least one hand object.

8. The method of claim 7,
wherein determining whether the at least one hand object is a hand of the user based on a distance between an utterance position of the user and the at least one hand object comprises:
determining a left hand object closest to the user among a plurality of left hand objects located on a left side of the user and a right hand object closest to the user among a plurality of right hand objects located on a right side of the user, to identify each object as the user's hand.

9. The method of claim 4,
wherein matching the utterance of the user with the pointing gesture of the user comprises:
determining whether the at least one hand object is a hand of the user based on the utterance position of the user and the size of the at least one hand object.

10. The method of claim 9,
wherein determining whether the at least one hand object is a hand of the user based on the utterance position of the user and the size of the at least one hand object comprises:
determining that a hand object whose size is greater than a predetermined value is a hand of the user based on that the utterance position of the user is a front seat,
and determining that a hand object whose size is smaller than the predetermined value is a hand of the user, based on that the utterance position is a back seat.

11. An apparatus for executing a speech instruction, the apparatus comprising:
at least one memory storing instructions; and
at least one processor,
wherein the at least one processor is configured to execute the instructions to
classify an utterance intent from an utterance of a user, and generate a slot, wherein the slot includes a plurality of attributes, and a value of an object to be controlled by the user through a speech instruction and at least one attribute related to a position of the object is set to a predetermined value,
match the utterance of the user with the pointing gesture of the user based on the utterance position information and the pointing gesture information of the user, wherein the pointing gesture is a gesture indicating a position or a direction of an object to be controlled by the user through a speech instruction,
modify a value of at least one attribute set to the predetermined value based on the pointing gesture of the user,
determine a control instruction for performing the speech instruction of the user based on the utterance intent and the modified slot, and
cause a controller to operate a vehicle control based on the control instruction.

12. The apparatus of claim 11,
wherein the slot comprises a target attribute and a position attribute, and the target attribute is an object that the user intends to control via a speech instruction, and the position attribute is a position of the object.

13. The apparatus of claim 12,
wherein the pointing gesture information comprises information about at least one hand object, and the information about the at least one hand objects comprises one or more of a position, a size, a shape, a type (a left hand or a right hand), or motion information of each hand object.

14. The apparatus of claim 13,
wherein before matching the utterance of the user with the pointing gesture of the user,
a plurality of hand objects that overlap each other are distinguished and separated; and
whether the at least one hand object is a right hand or a left hand is distinguished.

15. The apparatus of claim 14,
wherein in order to match the utterance of the user with the pointing gesture of the user, it determines whether the at least one hand object is a hand of the user based on the utterance position of the user and the position and type of the at least one hand object.

16. The apparatus of claim 15,
wherein a left hand object located on a left side of the user and a right hand object located on the right side of the user are determined to be hand of the user.

17. The apparatus of claim 14,
wherein in order to match the utterance of the user with the pointing gesture of the user, it determines whether the at least one hand object is a hand of the user based on a distance between an utterance position of the user and the at least one hand object.

18. The apparatus of claim 17,
wherein a left hand object closest to the user among a plurality of left hand objects located on the left side of the user and a right hand object closest to the user among a plurality of right hand objects located on a right side of the user are determined to be hands of the user.

19. The apparatus of claim 14,
wherein in order to match the utterance of the user with the pointing gesture of the user, it determines whether the at least one hand object is a hand of the user based on the utterance position of the user and the size of the at least one hand object.

20. The apparatus of claim 19,
wherein, based on that the utterance position of the user is a front seat, a hand object whose size is greater than a predetermined value is determined to be a hand of the user, and based on that the utterance position is a back seat, a hand object whose size is smaller than the predetermined value is determined to be a hand of the user.
